(19) United States
(12) Patent Application Publication
(10) Pub. No.: US 2026/0112910 A1
(43) Pub. Date: Apr. 23, 2026

(54) PULSED FAST-CHARGING METHOD WITH REGULATED-AMPLITUDE VOLTAGE INCREMENTS

(71) Applicants: STELLANTIS AUTO SAS, Poissy (FR); CENTRE NATIONAL DE LA RECHERCHE SCIENTIFIQUE, Paris (FR); INSTITUT POLYTECHNIQUE DE GRENOBLE, GRENOBLE (FR); SAFT, LEVALLOIS PERRET (FR); UNIVERSITE GRENOBLE ALPES, SAINT MARTIN D'HERES (FR); UNIVERSITE SAVOIE MONT BLANC, CHAMBERY (FR)

(72) Inventors: Francis Roy, LES ULIS (FR); Guillaume MERMAZ ROLLET, CERNAY LA VILLE (FR); Thomas PEUCHANT, Le Bouscat (FR); Rakesh KHATOKAR AMARNATH, Grenoble (FR); Anas LAHLOU, Bordeaux (FR); David HERPE, Tresses (FR); Pierre Xavier THIVEL, GRENOBLE (FR); Jean Claude LEPRÊTRE, Voreppe (FR); Yann BULTEL, Voreppe (FR)

(21) Appl. No.: 19/154,287

(22) PCT Filed: Jan. 8, 2024
(86) PCT No.: PCT/FR2024/050014

§ 371 Date: Aug. 6, 2025

(30) Foreign Application Priority Data
Feb. 27, 2023 (FR) FR2301779

(51) Int. Cl. H02J 7/90; B60L 53/10; B60L 53/62; H02J 7/94; H02J 7/96

(52) U.S. Cl. CPC H02J 7/927; B60L 53/11; B60L 53/62; H02J 7/933; H02J 7/94; H02J 7/965

(57) ABSTRACT

The present invention relates to a method for carrying out pulsed charging of an energy storage element (4) comprising, in a first phase of a charging cycle (E1), controlling a voltage profile (VC) having voltage regulation-driven increments (S1, S2, S3, S4, S5) defining a current profile (IC) in a charging cycle of a predetermined duration, and wherein a voltage increment (S1, S2, S3, S4, S5) is computed at a voltage amplitude at the time of a calculation step i according to a function depending on an estimate of the no-load voltage and on an estimate of the internal resistance at said time, on a coefficient n determining the charging duration and on the nominal capacity of the storage element. The invention is applicable to the fast-charging protocol, in particular for electromobility applications.

### CROSS-REFERENCE TO RELATED APPLICATIONS

This application is the US National Stage under 35 USC § 371 of International Application No. PCT/FR2024/050014, filed Jan. 8, 2024, which claims the priority of French application No. 2301779 filed on Feb. 27, 2023, the content (text, drawings and claims) of both said applications being incorporated by reference herein.

### BACKGROUND

Disclosed herein is a method for carrying out pulsed charging of an energy storage system using electrochemical cells.

In the industry of high-power energy storage systems, manufacturers are looking to develop fast-charging protocols that optimize charging speed and avoid cell ageing.

Known charging protocols run in two successive phases, referred to by the acronym CC-CV (Constant Current-Constant Voltage). FIG. 1 depicts an example of a conventional CC-CV charging protocol, where the state-of-charge (SOC) is represented by the dotted curve. The first phase, with reference sign PH1, consists in driving a constant charging current (represented by the CC curve) until the cell voltage (represented by the U-curve) reaches a maximum voltage recommended by the manufacturer. These protocols then provide for a second phase PH2 at constant voltage equal to maximum voltage. The purpose of the maximum voltage is to avoid the undesirable chemical phenomenon of lithium plating. This type of charging protocol requires a compromise between the charging speed and the temperature rise in order to limit cell ageing. Indeed, the first conventional charging step PH1 in the CC-CV protocol is carried out at constant current, which contributes to raising the cell temperature. The potentiostatic increment in the second phase PH2 significantly increases the overall recharge time.

In addition, the maximum charging current in CC-CV indicated by the cell manufacturer is also determined so as not to generate parasitic reactions that could lead to electrolyte degradation and lithium plating on the negative electrode, which could lead to the formation of dendrites and thus to the observation of short-circuits. Beyond the safety aspects, this phenomenon leads to a drop in cell capacity, a degradation of battery components, especially the electrolyte, and an increase in the internal resistance thereof. This phenomenon thus accelerates cell ageing, which in turn reduces performance.

These constraints make it difficult to increase the charging speed of a cell in the CC-CV protocol, and generally lead to significant cell overheating. For example, for devices conventionally used for electric traction of a motor vehicle, implementing this protocol, it is difficult to achieve charging speeds in excess of 2C-Rate (charging current value for a full charge in half an hour).

To overcome this drawback, it is possible to opt either for electrode loading values that accept higher cycling currents, at the expense of cell capacity, or to use other chemistries, but which then provide lower energy density.

In addition, it is known to resort to alternative pulse-controlled charging protocols to avoid lithium plating. A pulse control alternates between a charge pulse and a zero-current relaxation phase, or a polarity inversion phase. These last two phases do not give the lithium enough time to deposit in metallic form on the electrode. This protocol therefore makes it possible to extend the useful life of the cell even when the maximum voltage limit of 4.2 V is exceeded. The following documents describing pulse-controlled protocols are known from the state of the art.

The applicant has filed document WO-A1-2021156553 describing a voltage-regulated pulsed charging method with a variable amplitude increment depending on the variation in the internal resistance of the cell. This method is advantageous in that it offers a charging technique that improves thermal control of the cells.

Furthermore, the following state of the art has been identified in this document. Document US-B1-6707272 describes a protocol in which the pulses are limited by a voltage that depends on the current state-of-charge of the cell. When the voltage reaches the voltage limit, the protocol drives a relaxation phase. Document EP-A2-1396061 describes a protocol for driving current regulation pulses. The protocol alternates between pulses, chopped at the resonant frequency of the battery, in the range of 100 to 10,000 Hz, and lasting between 200 and 1,500 milliseconds, and relaxation and discharge phases of up to 1,500 milliseconds and 50 milliseconds, respectively. Also known is document US-A1-20150028819, FIG. 4 of which describes a four-stage charging protocol. A constant-current pre-charge (CC mode), a constant-current main charge (CC mode), a current-regulated pulsed charge at the constant Isup value (pulse mode) and a constant-voltage phase (CV mode). Document US-A1-20170005497 describes a protocol for pulsed charging by driving constant amplitude voltage pulses followed by a relaxation phase to limit the aging effect. According to this protocol, the duration and amplitude of the charging, discharging and relaxation phases are randomly driven, enabling the charge current to be increased without damaging the cell. Document WO-A1-2019111226A1 describes a pulsed charging protocol driven by non-linear voltage regulation, aimed at reducing charging time, in which the charging voltage is driven by keeping constant the product of the time derivative of the current and that of the voltage. Note that the recharging ends when the cell voltage reaches a maximum value.

The results of the known state of the art reveal that there is no universal solution for reducing charging time without increasing cell ageing. The algorithms generally proposed for the batteries are complex and require the development of a control technique specific to each battery system, due to the diversity of chemistries and their design.

### SUMMARY

The aim is to alleviate the above-mentioned problems and to provide rapid charge control for electrochemical cells. In particular, one aim is to propose a technique for controlling pulsed charging using a voltage profile driven by voltage regulation, enabling the battery to be recharged within a given time limit while preserving the useful life of its operational cycle.

More precisely, disclosed herein is a method for carrying out pulsed charging of an energy storage element comprising, in a first phase of a charging cycle, controlling a voltage profile having voltage regulation-driven increments defining a current profile in a charging cycle of a predetermined duration, and wherein a voltage increment is computed according to the following equation [Math 1]:

$$V ( soci ) = {V}_{ocv} ( soci ) + ( {R}_{i} * \frac{{Q}_{nominal}}{n * 1 h} )$$

Where, V(SOCi) is the voltage amplitude of an increment computed at the time of a calculation step i, Vocv(SOCi) is the estimate of the no-load voltage as a function of the state-of-charge of the storage element at step i expressed in volts, Ri is the estimate of the internal resistance of the storage element at step i expressed in milliohms, n is the coefficient defining the predetermined charging duration in hours, and Qnominal is the nominal capacity of the storage element in mAh.

The method may comprise the following additional features, alone or in combination:
the duration of an increment of the voltage profile is limited by the value of the charging current of the current profile with respect to a first minimum current threshold, a new increment value of the voltage profile being recomputed at the times at which the charging current reaches the first minimum current threshold;
the value of the first minimum current threshold is variable and specific to each increment of the voltage profile;
the value of the first minimum current threshold varies in a decreasing manner during the charging cycle between a first current value and a second current value;
the duration of an increment of the voltage profile is limited to a predetermined duration, and a new increment value in the voltage profile is recomputed as soon as the increment duration reaches the predetermined duration;
the first phase of the charging cycle ends when the amplitude value of an increment reaches a second voltage threshold, then the method comprises a second phase of the charging cycle with voltage pulses, the second phase alternating voltage pulses and relaxation phases, the amplitude of the voltage pulses being computed according to the equation Math 1;
the value of the second voltage threshold is equal to the maximum permissible voltage of the energy storage element in nominal operation;
the second phase ends when the voltage of the storage element reaches a third predetermined voltage threshold corresponding to a maximum authorized state-of-charge of the storage element;
the voltage pulses and the relaxation phases of the second phase form a periodic voltage profile having a rectangular, triangular, trapezoidal or sinusoidal shape;

A device for charging an energy storage element is envisaged, comprising a control unit that is configured to implement the charging method according to any one of the preceding embodiments.

Also envisaged is an assembly comprising the charging device for charging an energy storage element, the energy storage element and a control unit configured to implement the charging method according to any one of the preceding embodiments.

Also disclosed here in is an electrified motor vehicle comprising the charging device for charging an energy storage element, the energy storage element and a control unit configured to implement the charging method according to any one of the preceding embodiments.

Also provided herein is a computer program comprising instructions which, when the program is executed by a control unit of the charging device, cause the latter to implement any one of the embodiments of the pulse charging method.

The method improves performance in terms of charging speed, thermal control and cell ageing limitation.

### BRIEF DESCRIPTION OF THE FIGURES

Other features and advantages will become clearer on reading the following detailed description comprising embodiments given by way of non-limiting examples and shown by the appended drawings, wherein:

FIG. 1 is a graphic depicting a known charging control technique of the type with DC control described in the preamble to this description.

FIG. 2 depicts a functional block diagram of a charging system of an energy storage system intended to implement the charging method.

FIG. 3 is a graphic illustrating a first embodiment of the time-limited charging method with voltage increments during a complete charging cycle of an energy storage system.

FIG. 4 is a graphic illustrating a second embodiment of the voltage-limited charging method with voltage increments during a complete charging cycle of an energy storage system.

FIG. 5 is a graphic describing an alternative embodiment of the voltage profile controlled in the first phase.

FIG. 6A is a graphic depicting an alternative embodiment of a triangular voltage profile controlled in the second phase.

FIG. 6B is a graphic depicting an alternative embodiment of the trapezoidal voltage profile controlled in the second phase.

FIG. 7A shows a test scenario of the charging method for an NMC/graphite electrochemical cell.

FIG. 7B shows the evolution of the state-of-charge and temperature during the execution of the test.

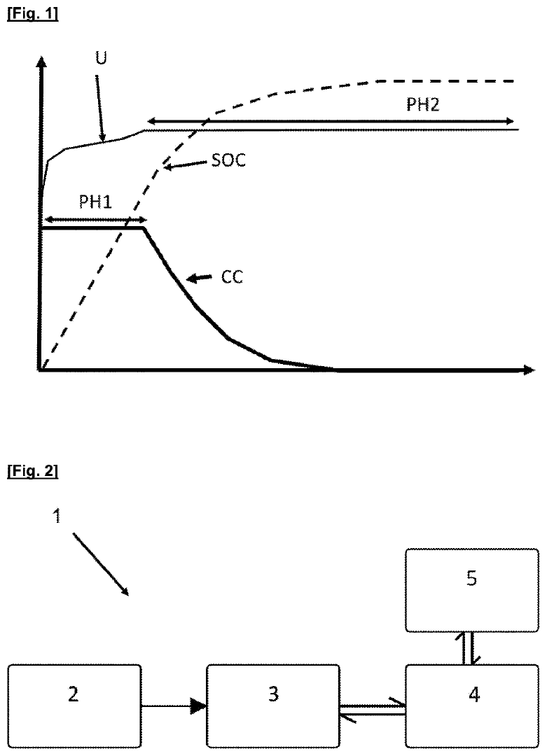

### DETAILED DESCRIPTION

Disclosed herein is a technique for controlling pulsed charging with a controlled voltage profile. It applies in particular to energy storage systems for electromobility applications, especially electrified motor vehicles, as well as to stationary energy storage systems, especially for renewable energy installations and grid regulation. These high-power storage systems are made up of an energy storage element made up of individual sub-elements, referred to as electrochemical cells, electrically interconnected in a particular configuration intended to comply with the electrical specifications of the system. Generally, the cells are connected electrically in series and/or in parallel so as to have an electrical capacity and operating voltage that complies with these specifications. The described methods and devices relate to the charging of high-power energy storage systems having at its terminals a voltage of several hundred volts, for example 350 volts or 1000 volts, or even up to a maximum voltage of 1500 volts or more, particularly for stationary storage systems. However, it is envisaged for the charging method to apply to the charging of a single cell or to low power systems, for example of the order of a few volts or tens of volts, especially for portable electronic devices. An energy storage element can therefore be a single cell or a group of cells.

An electrochemical cell is an electrical energy accumulator with two terminals, a positive and a negative electrode, and a voltage of a few volts, usually between 2.3 V and 4.2 V. The cells can be of the Lithium-ion type (e.g. an oxide of lithium Nickel Manganese Cobalt NMC), Nickel Cadmium (Ni—Cd), Nickel-Metal-Hydride (Ni-MH), for example. More specifically, a Lithium-ion cell consists mainly of a porous positive electrode, a porous negative electrode, a separator and an electrolyte. The operating principle of a lithium-ion cell is based on the reversible exchange of lithium ions between the two porous electrodes. Cells can be of the Lithium iron phosphate, Lithium polymer or solid electrolyte type, for example.

Furthermore, the charging method can be applied to electrochemical battery systems said to have a multilevel inverter structure. This type of system comprises elementary cell modules interconnected to form a distributed multilevel inverter structure in the battery, allowing the battery to be connected to an electrical system operating with DC voltage and also with AC voltage without the intermediary of an inverter. Thus, it can be connected directly to an extended power supply network operating with AC voltage and to an electric drive machine. Examples include documents WO-A1-2017/153366, WO-A1-2021/048477 and FR-A1-3121797, which describe this type of architecture.

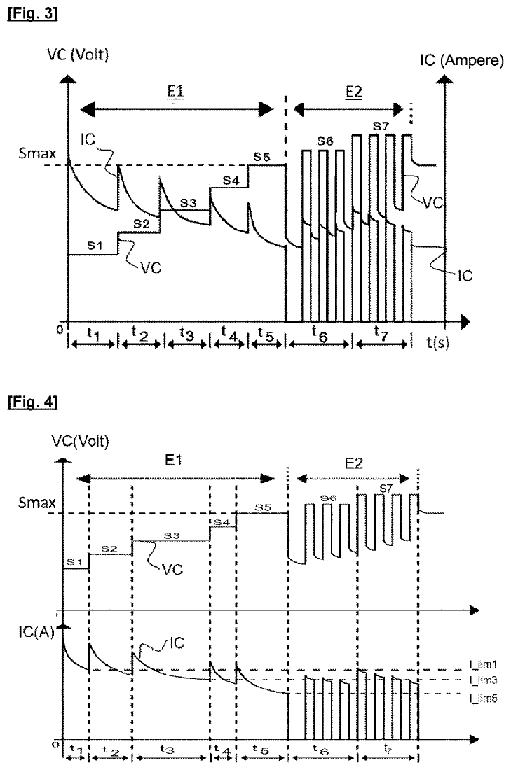

FIG. 2 schematically depicts functional blocks of a charging assembly 1 comprising an energy storage system 4 with electrochemical cells. This assembly includes an energy source 2, which may be an extended power supply network operating with AC voltage, a charging device 3 provided with a voltage converter of the AC-DC type making it possible to drive the voltage profile by increments and pulses in accordance with the charging method. The storage system 4 is, for example, a battery of an electrified motor vehicle or a stationary battery. The charging device 3 may be the on-board charger of a vehicle or the charger of a so-called fast-charging station directly delivering a DC voltage adapted to the energy storage system 4. In addition, the energy storage system 4 is driven by a control unit 5 for its operation, referred to as BMS (Battery Management System) or BCU (Battery Control Unit).

More precisely, the charging device 3 includes power electronic means capable of driving a charging voltage profile with increments or voltage pulses determining a charging current profile of the energy storage system 4. The voltage converter includes a unit provided with several MOSFET transistors driven by its computer. These transistors are arranged and driven by a program for scheduling the opening and closing state in order to convert the input AC voltage (single-phase or three-phase) into a charging voltage according to the voltage profile.

More specifically, the control unit 5 is provided with an integrated-circuit computer and electronic memory units, as well as with means for acquiring operating parameters of the storage system 4, such as the temperature, the voltage, the value of the charging/discharging current flowing through the cells, the state-of-charge (SOC) and the internal resistance of a cell, especially. The control unit 5 also includes cell characterization models or maps stored in memory and obtained by experimental means, especially maps of the no-load voltage as a function of an estimate of the state-of-charge and the internal resistance of the cells. Data communication means are provided between the storage system 4 and the charging device 3, enabling the exchange of information concerning the electrical parameters of the storage system 4 and the charging device 3 in order to implement the charging method.

State-of-charge refers to the state-of-charge of the battery, expressed as a ratio between the amount of energy stored at a given time and the maximum amount of energy that can be stored at a given time, generally expressed as a percentage. The state-of-charge can be estimated at any time from a known initial state-of-charge and by coulometric measurement between two times of measuring the charging current according to the following equation:

$${SoC}_{i + 1} = {SoC}_{i} + \frac{{\overline{I}}_{i} * \overline{Δ {t}_{l}}}{{Q}_{nominal}} and {\overline{I}}_{i} = \frac{{\int }_{{t}_{i}}^{{t}_{i} + \overline{Δ {t}_{l}}} Idt}{\overline{Δ {t}_{l}}} \qquad [ Math 2 ]$$

Where, Īᵢ is the average current at the measurement step i, Δ̅t̅ᵢ̅ is the estimated average time between the two measurement steps i and i+1 and SoCᵢ is the estimated state-of-charge at the measurement step i.

The no-load voltage (also referred to as open-circuit voltage or OCV) is a measurement of the electromotive force of the cell. This measurement depends on the state-of-charge of the cell. The OCV is the voltage difference between the terminals of a cell when the circuit is open, i.e. in the no-load condition.

Internal resistance is defined as the opposition to the flow of current through the cell. The basic parameters which affect the internal resistance are ohmic resistance and ionic resistance, which are temperature-dependent. Ohmic resistance includes the resistance of the components of the cell such as the positive electrode, the negative electrode and the current collector. Conversely, ionic resistance is the resistance exhibited mainly by the electrolyte against the flow of ions. It is assumed that the ionic resistance is negligible compared to the ohmic resistance, since the polarization effect is slow compared to the ohmic resistance.

The charge rate ratio or C-rate is defined as a charging or discharging current value defining the rate at which a battery or cell is fully charged or discharged. For example, 1C-rate corresponds to a current value enabling full charging or discharging in 1 hour, 3C-rate corresponds to a current value enabling charging or discharging in 20 minutes, and 0.5C-rate in 2 hours.

Charging cycle is understood to mean a charging sequence, i.e. from 0% to 100% SOC, or more generally in the case of electrified vehicles from 10% to 90% SOC. A charging cycle can also be defined by the time from the start of charging until stopping and disconnecting from the power source.

Characterizing the cells involves using experimental techniques known to skilled persons in the field of electrochemical cells to determine the characteristic parameters of the cells in operation, such as internal resistance and OCV. For example, internal resistance can be mapped using the so-called current interrupt (CI) technique present in the EC-lab software from BioLogic®. The OCV can be mapped by measuring the voltage with different states-of-charge under given temperature conditions. The characterization parameters are stored in the memory of the control unit of the battery and can be determined at each time.

For example, the OCV at each time can be determined from a map taking as input an estimate of the state-of-charge, and the internal resistance from a map taking as input a temperature measurement and an estimate of the state-of-charge.

The control functions of the control unit 5 and the charging device 3 can be implemented in the form of software modules, or electronic circuits (hardware) or a combination of electronic circuits and software modules, such as ASICs (Application Specific Integrated Circuits) or DSPs (Digital Signal Processors).

The charging device 3 is configured to implement the two-phase pulsed charging method described hereinbefore, ensuring a complete charging cycle within a predetermined timeframe, while limiting the effects of cell ageing.

FIGS. 3 and 4 describe two embodiments of the charging method for a charging cycle between 10% SOC and 90% SOC. The first phase E1 with voltage increments and the second phase E2 with voltage pulses consist in driving a voltage profile with voltage increments or voltage pulses of controlled amplitude according to the following equation:

$$V ( soci ) = {V}_{ocv} ( soci ) + ( {R}_{i} * \frac{{Q}_{nominal}}{n * 1 h} ) \qquad [ Math 3 ]$$

Where, V_{(soci)} is the voltage amplitude of an increment computed at the time of a calculation step i, Vocv (SOCᵢ) is the estimate of the no-load voltage as a function of the state-of-charge of the storage element at step i expressed in volts, Ri is the estimate of the internal resistance of the storage element at step i expressed in milliohms, n is the coefficient defining the predetermined charging duration in hours, and Qₙₒₘᵢₙₐₗ is the nominal capacity of the storage element in mAh.

For example, the coefficient n has a value of ⅓ for a desired charge time of 20 minutes for a full charging cycle of an energy storage element.

The value of the voltage amplitude is carefully controlled over the charging cycle as a function of a first component dependent on the monitoring of the no-load voltage (OCV), and a second component designed to compensate for ohmic losses linked to variations in the state-of-charge of a cell, as well as to limit the duration of the charging cycle. This voltage control enables the charge current profile to be driven so that the entire charging cycle is completed within the required time.

More precisely, the first phase begins at the start of the charging cycle. The initial state-of-charge for triggering the first phase can be between 0% and 70% of the SOC of the energy storage element, preferably the first phase is triggered when the SOC is at least equal to or greater than 10%. In automotive applications, battery discharge below an SOC of 10% is generally prohibited. Consequently, the first phase with a voltage profile driven according to the amplitude defined by the equation Math 3 is applied as soon as a charging cycle is triggered. Nevertheless, below 10% SOC, DC charge control can be provided due to the high internal resistance in this operating range of a cell, for example at a charge rate ratio of 0.5C-rate.

Referring to FIGS. 3 and 4, in this example of the protocol, the first phase E1 comprises five calculation steps or increments, with reference signs S1, S2, S3, S4 and S5, and the second phase E2 includes two calculation steps or increments, with reference signs S6 and S7. Other numbers of steps are possible for a charging cycle, for example between 5 and 100.

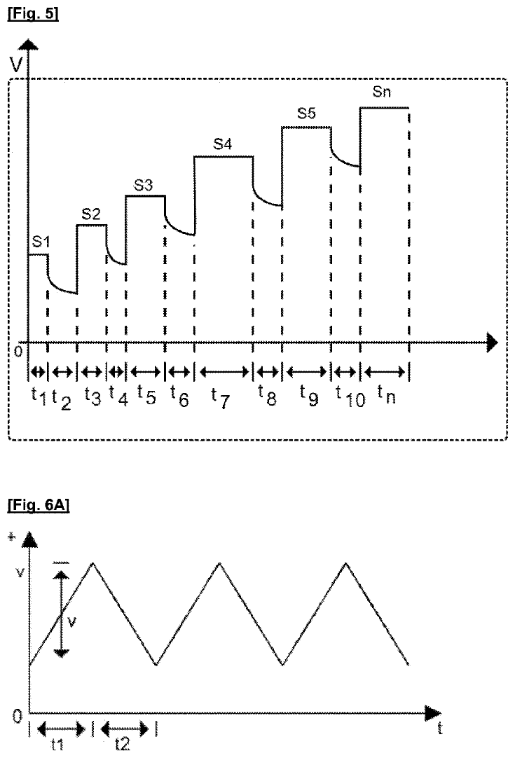

In the first phase E1, the voltage increments increase and preferably follow one another without incorporating relaxation phases, thus having a stepped voltage profile. However, it is envisaged that the first phase E1 may also include relaxation phases between each increment, as shown in FIG. 5.

The voltage of the first increment S1 can be between 3.7 volts and 3.9 volts. The first phase E1 ends when the amplitude of a voltage increment driven by the charging device 3 and computed according to the equation Math 3 becomes equal to or greater than the maximum voltage threshold Smax. Smax corresponds to the maximum permissible cell or battery voltage, referred to as “upper cut-off voltage”. This threshold Smax is determined by the manufacturer of the energy cell being charged and depends mainly on the chemistry. For a single NMC cell, this threshold Smax is generally close to 4.2 volts.

In the second phase E2, the voltage pulses alternate with relaxation phases. The voltage pulses have constant voltage values computed according to the equation Math 3 at each computation step S6 and S7 having a predetermined duration. During the second phase with voltage pulses, the charging cycle ratio can be set, for example, to a pulse duration of 0.8 s and 0.2 s, giving a duty cycle factor of 80%. The pulse amplitude values during the second phase E2 are higher than the threshold Smax, for example between 4.2 volts and 4.65 volts. This high voltage reduces the charging time in the last phase to between 80% and 90% SOC. The relaxations, which unlike in the first phase E1 are compulsory, make it possible to prevent undesirable chemical reactions of lithium plating and heating of the cells. As a result, the aging effect is reduced. The relaxations give the lithium ions time to settle properly on the host site, making the system more fluid.

Two different embodiments of the charging protocol are described next. FIG. 3 depicts a first embodiment in which the increments S1, S2, S3, S4 and S5 of the voltage profile are limited by a predetermined duration during the first phase E1. To simplify the graphical representation, in this example the charging cycle from 10% to 90% SOC is driven by seven increments of voltage amplitudes according to the equation Math 3. Each increment has an equal duration, predetermined by the number of increments required and the desired charging duration. According to this first embodiment, as soon as the increment duration has reached the predetermined duration, a new increment value is driven to a higher value that makes it possible to compensate for ohmic losses. It is noted that at the start of each increment, the current profile IC begins at an initial maximum value and then decreases exponentially as the internal resistance gradually increases. When a new increment is driven to a higher value, the charging current is increased. The phase E1 is controlled until the value of the voltage increment reaches the threshold Smax. At the end of S5, the second phase E2 is triggered and the voltage profile is regulated according to a pulse cycle with a charging rate of 80%. The relaxation is selected at a voltage value that determines zero charging current IC during relaxation. It can be seen that the current profile IC resulting from the voltage pulses starts at a maximum value and then falls exponentially.

The increment durations t1, t2, t3, t4, t5 are of equal value, for example comprised in a range from 5 s to 90 s. In this example, the durations t6 and t7 of the calculation steps of the second phase E2 are of higher value. The number of increments, depending on the selected duration and the length of the charging cycle, can range from 6 to 90 increments.

In one variant of this first embodiment, the successive durations t1, t2, t3, t4, 15 are set to values that are mutually discrete and decrease in value. In another variant of this first embodiment, the durations set are selected randomly or in such a way as to give priority to the duration of one increment over the others. For example, an intermediate increment in an SOC zone of the cell where the internal resistance has been observed to increase less rapidly can be maintained for a longer duration.

FIG. 4 depicts a second embodiment of the charging method, in which the voltage increments are limited by the value of the charging current IC with respect to a current threshold I_limₙ that is specific to each increment Sn. In this example, seven voltage increments S1, S2, S3, S4, S5, S6 and S7 are computed according to the equation Math 3. A new voltage amplitude value is computed as soon as the current reaches or exceeds the minimum limit I_limₙ associated with the increment Sn. The values of the current limits I_limₙ decrease as the recharging progresses. For example, as a function of the set value of n, these values can vary in a range of charge rate ratios from 4C-Rate to 2C-Rate, allowing the recharging of up to 80% SOC in 20 minutes.

Referring to FIG. 4, for the sake of clarity, only the limits I_lim1, I_lim3 and I_lim5 are depicted, for voltage increments S1, S3 and S5, respectively. The current limits I_lim2 and I_lim4 are not indicated, but are intended to trigger the computation of a new increment value of the voltage profile. As can be seen, at the first voltage level S1, the IC current profile decreases exponentially. As soon as the current IC reaches the threshold I_lim1, the method computes a new increment value S2, similarly for increment S2, as soon as the current IC reaches the limit I_lim2, a new increment value S3 is computed, and so on until the increment amplitude reaches the upper cut-off voltage Smax.

At the end of S5, the second phase E2 is triggered and the voltage profile VC is regulated according to a voltage pulse cycle with a charge rate of 80%, in which the duration of each step of computing the voltage amplitudes is predetermined. The relaxation is selected at a voltage value that determines zero charging current IC during relaxation. It can be seen that the current profile IC resulting from the voltage pulses starts at a maximum value and then falls exponentially. During the second phase E2, the voltage profile is a rectangular periodic profile.

FIG. 5 depicts a graph describing an alternative embodiment of the first phase E1, in which the charging device controls the voltage-regulated voltage profile according to voltage increments Sn computed in accordance with the equation Math 3, and wherein relaxation phases are provided between each increment.

In one alternative, it is provided, during the phase E1, for the voltage increments computed according to the equation Math 3 to alternate with relaxation phases over a predefined range of SOC and, over another range of SOC, for the charging method to control only the voltage increments.

In a further variation, it is envisaged that during the phase E1, in a single charging cycle, the voltage increments can be limited by a predetermined duration over a first range of SOC, and that the voltage increments are limited by a current limit over a second range of SOC.

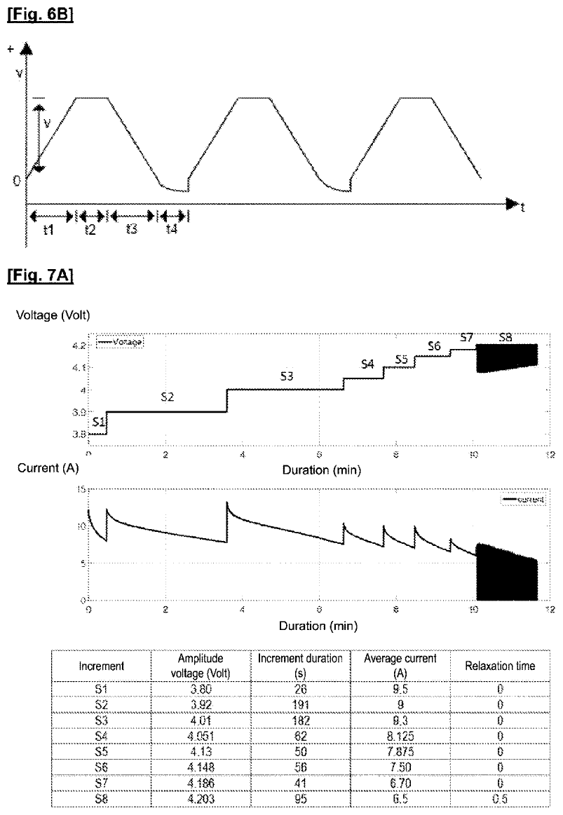

FIGS. 6A and 6B depict two further variants of the voltage profile for the second phase E2. The X-axis shows the duration in seconds and the Y-axis shows the voltage value of the charging voltage profile VC. Instead of being rectangular, the voltage profile controlled by the charging device can be triangular, as shown in FIG. 6A. A voltage pulse then corresponds to the part with a positive slope—the duration t1—and the relaxation phase then corresponds to the part with a negative slope—the duration t2. The voltage peak of the triangular shape is computed according to the equation Math 3.

In FIG. 6B, the voltage profile controlled by the charging device is trapezoidal. A voltage pulse then corresponds to the part with a positive slope—the duration t1—and the relaxation phase then corresponds to the part with a negative slope—the duration t3. The duration t2 corresponds to the voltage increment or step of the pulse. The value of the voltage increment is computed according to the equation Math 3.

The phases with negative slope of the voltage profile make it possible to limit the effect of lithium plating and limit ageing. It periodically slows down the flow of lithium ions. These profiles are particularly useful for rapidly finalizing recharging in the 80% to 90% SOC range. Other shapes are possible, such as a sinusoidal shape.

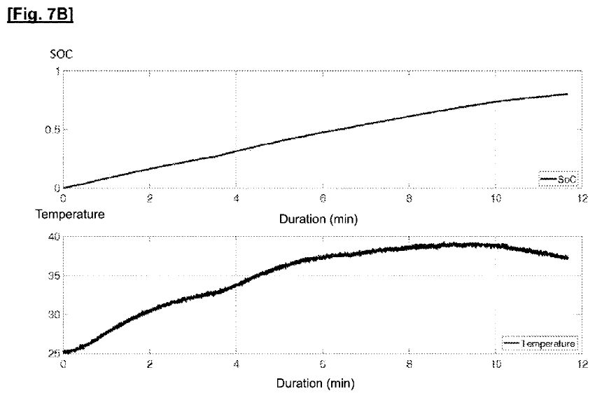

FIG. 7A shows a test scenario for an NMC/graphite cell with the following specifications: 3.6 volts and 200 mAh. The graphs at the top show the voltage profile driven, and the ones at the bottom show the current profile resulting from the driven voltage profile. The X-axis shows the duration of the charging cycle, which takes less than 12 minutes to complete. In this scenario, the cell is charged from 0% to 80% SOC. The table at the bottom shows the parameters of the voltage profile and the resulting current profile, especially the voltage amplitude and the duration of each increment, the average charging current, as well as the duration of the pulse and of the relaxation during the second pulse phase.

In FIG. 7B, two graphs show the evolution of the SOC expressed between 0 and 1 and the temperature in degrees Celsius of the cell during the execution of the test scenario.

The charging method has the advantage of reducing battery recharging time, resulting in an electric vehicle that is better suited to the market. In addition, it makes it possible to limit the temperature rise of the battery during recharging, with the result that the thermal power to be evacuated by the cooling system is greatly reduced, implying a reduction in the cost of the architecture of the battery cooling system. The method also increases the useful life of the battery, guaranteeing the customer a useful life equivalent to that of the vehicle. In addition, thanks to improved thermal control, the car can be charged quickly even in hot climates. More generally, this charging solution helps lower the retail price of electric vehicles.

The methods and devices described herein advantageously concern rechargeable electrified vehicles, electric or so-called “Plug-in” hybrid vehicles comprising a charging device and a battery that can be charged according to a fast-charging protocol. Improved performance in terms of charging speed and temperature control makes it possible accordingly to increase the number of fast charges that a vehicle can accept in a given life cycle.

The methods and devices are described in the foregoing by way of example. It is understood that the person skilled in the art is capable of carrying out different variants by combining, for example, the various features hereinbefore, taken either alone or in combination, without thereby departing from the scope.

1. A method for carrying out pulsed charging of an energy storage element, wherein it comprises, in a first phase of a charging cycle, controlling a voltage profile having voltage regulation-driven increments defining a current profile in a charging cycle of a predetermined duration, and wherein a voltage increment is computed according to the following equation [Math 4]:
$$V ( soci ) = {V}_{ocv} ( soci ) + ( {R}_{i} * \frac{{Q}_{nominal}}{n * 1 h} ) ,$$
where, V(SOCi) is the voltage amplitude of an increment computed at the time of a calculation step i, Vocv (SOCi) is the estimate of the no-load voltage as a function of the state-of-charge of the storage element at step i expressed in volts, Ri is the estimate of the internal resistance of the storage element at step i expressed in milliohms, n is the coefficient defining the predetermined charging time in hours, and Qnominal is the nominal capacity of the storage element in mAh.

2. The charging method according to claim 1, wherein the duration of an increment of the voltage profile is limited by the value of the charging current of the current profile with respect to a first minimum current threshold, a new increment value of the voltage profile being recomputed at the times at which the charging current reaches the first minimum current threshold.

3. The charging method according to claim 2, wherein the value of the first minimum current threshold is variable and is specific to each increment of the voltage profile.

4. The charging method according to claim 3, wherein the value of the first minimum current threshold varies in a decreasing manner during the charging cycle between a first current value and a second current value.

5. The charging method according to claim 1, wherein the duration of an increment of the voltage profile is limited to a predetermined duration, a new increment value of the voltage profile being recomputed as soon as the increment duration reaches the predetermined duration.

6. The charging method according to claim 1, wherein the first phase of the charging cycle ends when the amplitude value V(SOCi) of an increment reaches a second voltage threshold, then the method comprises a second phase of the charging cycle with voltage pulses, the second phase alternating voltage pulses and relaxation phases, the amplitude of the voltage pulses being computed according to the equation Math 4.

7. The method according to claim 6, wherein the value of the second voltage threshold is equal to the maximum permissible voltage of the energy storage element in nominal operation.

8. The method according to claim 6, wherein the second phase ends when the voltage of the storage element reaches a third predetermined voltage threshold corresponding to a maximum authorized state-of-charge of the storage element.

9. The charging method according to claim 6, wherein the voltage pulses and the relaxation phases of the second phase form a periodic voltage profile having a rectangular, triangular, trapezoidal or sinusoidal shape.

10. A device for charging an energy storage element comprising a control unit that is configured to implement the charging method according to claim 1.

11. An assembly comprising the charging device for charging an energy storage element, the energy storage element and a control unit configured to implement the charging method according to claim 1.
